(19) United States
(12) Patent Application Publication
(10) Pub. No.: US 2010/0241730 A1
(43) Pub. Date: Sep. 23, 2010

(54) INFORMATION PROCESSING APPARATUS, INFORMATION PROCESSING METHOD AND COMPUTER READABLE RECORDING MEDIUM

(75) Inventors: Kensaku FUJIMOTO, Kawasaki-Shi (JP); Satoshi Ozaki, Kawasaki-Shi (JP); Yoshiki Terashima, Yokohama-Shi (JP); Shirou Wakayama, Kawasaki-Shi (JP); Kenji Odaka, Yokohama-Shi (JP); Eiji Tokita, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/561,808

(22) Filed: Sep. 17, 2009

(30) Foreign Application Priority Data
Mar. 23, 2009 (JP) 2009-069538

(51) Int. Cl. G06F 15/16

(52) U.S. Cl. 709/218

(57) ABSTRACT

An information processing apparatus has an information acquiring unit which acquires a plurality of pieces of information over a network in accordance with an acquisition script included in a scenario, an information converting unit which extracts portions represented to a user from the respective pieces of acquired information in accordance with a conversion script included in the scenario, a movement adding unit which processes all or part of the presented portion so that display contents can be presented in such a form as to change and/or be accompanied with the sound output in accordance with a movement adding script included in the scenario, a statistics recording unit which records processing cost for each of the information acquiring unit, the information converting unit and the movement adding unit, an extraction unit which extracts dependency information showing a dependency relationship between the processes from the scenario, and a control unit which determines the priority of the processes to be carried out on the basis of the scenario, the dependency information and the processing cost, and controls the information acquiring unit, the information converting unit and the movement adding unit.

### CROSS REFERENCE TO RELATED APPLICATION

This application is based upon and claims benefit of priority from the Japanese Patent Application No. 2009-69538, filed on Mar. 23, 2009, the entire contents of which are incorporated herein by reference.

### BACKGROUND OF THE INVENTION

The present invention relates to an information processing apparatus, an information processing method, and a computer readable recording medium. As a mode of watching television (using a television set), there is a mode of turning on a television set only during the time a certain program is to be watched (or looked at), a mode of watching television while doing some other things, and in addition, a mode of leaving on the television all the time so that only the sound is listened to, the television is glanced at, or the television is occasionally looked at, if necessary, and a mode of using the television set as a backdrop or a music source instead of actively viewing the television. The mode of using a television set by leaving it on all the time is widely done in various places, such as homes, shops and public facilities.

However, there is a limitation in television broadcasting such that only the information broadcasted by broadcasting stations can be received and reproduced. Therefore, though the television broadcast can be received and reproduced all the time, the number of program choices is limited to the number of broadcasting stations.

However, the Internet makes it possible to acquire a large amount of information in addition to the information broadcasted by the broadcasting stations. In addition, such a state in which everyone in the world can send information is about to be achieved. In this state, various types of information about various topics, such as politics, economics and hobbies, can be handled. Thus, a great amount of information that is incompatible with the television broadcast circulates through the Internet.

Televisions can acquire information only by turning on the power switch, and for example, selecting a channel. In addition, the displayed information chronologically changes even if the user does not actively operate the television set. Meanwhile, in order to acquire and look at information on the Internet, the user should have his or her own idea about what kind of information is to be acquired and looked at, and then, active operations are required such that an inputting operation is carried out on the basis of the idea and the information is sorted or the desired information is selected from among a great amount of information that is displayed.

Even if a browser on the Internet is kept operating, the same information is merely kept being displayed. In order to change the browser screen on the Internet, an active operation by the user is necessary, and it is difficult to change the screen without an active operation by the user.

In the case where the browser screen on the Internet changes without an active operation by the user, a simple operation is required to fast forward to information interesting to the user or review the missed information. In addition, when information is fast forwarded or rewound, it is required to shorten the intermission time of the displayed information so that the display can be restarted quickly.

### SUMMARY OF THE INVENTION

According to one aspect of the present invention, there is provided an information processing apparatus which acquires information over a network and processes the information to be displayed to a user on the basis of a scenario including an acquisition script, a conversion script and a movement adding script, comprising:

an information acquiring unit which acquires a plurality of pieces of information over the network in accordance with the acquisition script;

an information converting unit which extracts portions represented to the user from the respective pieces of information acquired by the information acquiring unit in accordance with the conversion script;

a movement adding unit which processes all or part of the presented portion extracted by the information converting unit so that display contents can be presented in such a form as to automatically change and/or be accompanied with the sound output in accordance with the movement adding script;

a statistics recording unit which records a first cost for the information acquiring unit to acquire information, a second cost for the information converting unit to extract the presented portion and a third cost for the movement adding unit to carry out the process;

an extraction unit which extracts dependency information showing a dependency relationship between the processes in the information acquiring unit, the information converting unit and the movement adding unit from the scenario; and

a control unit which determines the priority of the processes to be carried out on the basis of the scenario, the dependency information and the first to third cost, and controls the information acquiring unit, the information converting unit and the movement adding unit.

According to one aspect of the present invention, there is provided an information processing method using an information processing apparatus comprising an information acquiring unit, an information converting unit, a movement adding unit, a statistics recording unit, an extraction unit and a control unit, which acquires information over a network and carries out a process on information displayed to a user on the basis of a scenario including an acquisition script, a conversion script and a movement adding script, wherein

the extraction unit extracts dependency information showing a dependency relationship between the respective processes in the information acquiring unit, the information converting unit and the movement adding unit from the scenario,

the control unit determines the priority of the processes to be carried out on the basis of the scenario, the dependency information and the cost for the processes in the information acquiring unit, the information converting unit and the movement adding unit, which is recorded in the statistics recording unit, and gives instructions to the information acquiring unit, the information converting unit and the movement adding unit,

the information acquiring unit acquires a number of pieces of information over the network in accordance with the acquisition script and an instruction from the control unit,

the information converting unit extracts portions presented to the user from the respective pieces of information acquired by the information acquiring unit in accordance with the conversion script and an instruction from the control unit,

the movement adding unit processes all or part of the presented portions extracted by the information converting unit so that the portions are presented in such a form that the display contents automatically change and/or are accompanied by the sound output in accordance with the movement adding script and an instruction from the control unit, and

the statistics recording unit records a first cost for the information acquiring unit to acquire information, a second cost for the information converting unit to extract the presented portions, and a third cost for the movement adding unit to carry out the process.

According to one aspect of the present invention, there is provided a computer readable recording medium which records a program which allows a computer to function as an information processing apparatus for acquiring information over a network and carrying out a process on information displayed to a user on the basis of a scenario including an acquisition script, a conversion script and a movement adding script, wherein the program allows a computer to have:

a function for allowing an information acquiring unit to acquire a number of pieces of information over the network in accordance with the acquisition script;

a function for allowing an information converting unit to extract portions presented to the user from the respective pieces of information acquired by the information acquiring unit in accordance with the conversion script;

a function for allowing a movement adding unit to process all or part of the presented portions extracted by the information converting unit so that the respective portions are presented in such a form that the display contents automatically change and/or are accompanied by the sound output in accordance with the movement adding script;

a function for allowing a statistics recording unit to record a first cost for the information acquiring unit to acquire information, a second cost for the information converting unit to extract the presented portions, and a third cost for the movement adding unit to carry out the processes;

a function for allowing an extraction unit to extract dependency information showing dependency relationship between the respective processes in the information acquiring unit, the information converting unit and the movement adding unit from the scenario; and

a function for allowing a control unit to determine the priority of the processes to be carried out on the basis of the scenario, the dependency information and the first to third cost, and to give instructions to the information acquiring unit, the information converting unit and the movement adding unit.

### BRIEF DESCRIPTION OF THE DRAWINGS

FIG. 1 is a schematic diagram showing the configuration of a network system according to an embodiment;

FIG. 2 is a schematic diagram showing the configuration of the information processing apparatus according to the embodiment;

FIG. 3 is a graph showing the relationship between the processing time and the number of times processing is carried out in the information processing apparatus according to the embodiment;

FIG. 4 is a graph showing the probability distribution of the processing time in the information processing apparatus according to the embodiment;

FIG. 5 is a schematic diagram showing the configuration of the display time indicating apparatus according to the embodiment;

FIG. 6 is a diagram showing an example of the dependency relationship between the processes;

FIG. 7 is a diagram showing an example of an indication of fast forwarding; and

FIG. 8 is a flow chart for illustrating the information processing method according to the embodiment.

### DESCRIPTION OF THE EMBODIMENTS

In the following, the embodiments of the present invention are described in reference to the drawings.

The present embodiment allows a user to view various types of information on the Internet only by carrying out an operation as easy as turning on a television or selecting a channel instead of specific active operations.

At this time, the following situation is possible. A state of maintaining a moderate level of concentration when viewing information on the Internet for a long period of time or a state where no excessive concentration is required such that the television program is not being closely followed is referred to as “idle watching,” for example. This does not define what “idle watching” strictly means but covers other various states. In the present embodiment, such an environment that a user can “idly watch” various types of information on the Internet (environment similar to a state where a television is left on all the time) is assumed to be provided.

In order to provide the above-described environment, it is desirable to introduce at least the following two elements.

(1) Movement is added to the information on the Internet.

It is possible for the probability of the user paying attention to the screen to be high when something moves or changes on the screen in a state where the user is not paying attention to the screen. The same is possible when a sound is emitted or the emitted sound changes. It is also possible for the user to be immediately bored and stop watching the screen if no movement or change appear on the screen in a state where the user is watching the screen.

Therefore, it is desirable for the screen and/or the emitted sound to have a certain degree of change in order to make “idly watching” possible.

(2) The contents of the information on the Internet are changed.

It is possible for the user to tend to not watch the screen when the same information is kept being displayed or replayed continuously or intermittently over a long period of time, or the user looks at the same information many times even if the information initially interests the user.

Therefore, it is desirable to switch the displayed information in order to make “idly watching” possible. A large number of contents on the Internet are appropriate for “idly watching.”

Furthermore, it is desirable to introduce at least either of the following two elements concerning the point “no excessive concentration is required for the user.”

(3) The amount of information provided for viewing is limited.

The amount of information that people can acquire by glancing at the screen is limited to a certain extent, and therefore, it is possible for too much displayed information to require excessive concentration by the user. The prior art, for example, makes it possible to automatically scroll websites. However, most of the conventional websites are composed of texts, which require excessive concentration by the user because there are too many words, if the websites are displayed as it is. Therefore, it is desirable to limit the displayed information for “idly watching.”

(4) None or only a few choices are provided to the user. When choices for the user are possible on the screen, the user feels that it is necessary to make a selection, and it is possible for the user to need to concentrate to think. When websites are displayed by means of a conventional browser, for example, there are usually other choices by way of links. Therefore, it is desirable to limit the displayed information for “idly watching.”

Accordingly, it is desirable to reduce the number of choices as much as possible or completely eliminate choices for “idly watching.”

In the following, the present embodiment is described in further detail.

In the present embodiment, an information processing apparatus converts information on the Internet to video or sound, for example, along a channel scenario and displays it on a display apparatus.

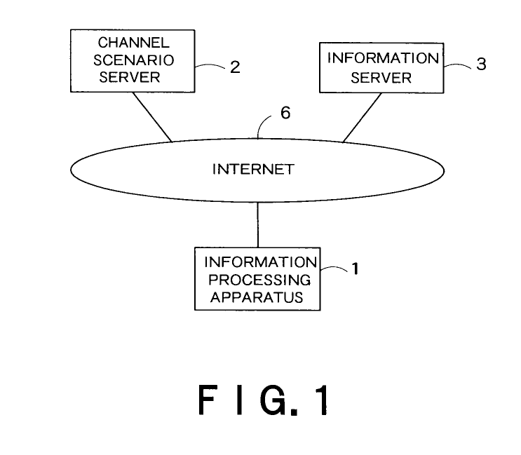

FIG. 1 shows an example of the configuration of a network system according to one embodiment of the present invention. The information processing apparatus 1 according to the present embodiment is connected to a channel scenario server 2 and an information server 3 over the Internet 6. The channel scenario server 2 is an external server for distributing channel scenarios. The information server 3 is an external server for providing information.

Here, there may be more than one channel scenario server 2. In addition, in the case where the information processing apparatus 1 is connected to a LAN (not shown), there may be a channel scenario server 2 on the LAN, so that the information processing apparatus 1 can acquire a channel scenario from the channel scenario server 2 on the LAN. This is the same for the information server 3.

In addition, the information processing apparatus 1 may be connected directly to the Internet 6, or connected through the LAN (not shown). The Internet 6 may be a network having another protocol.

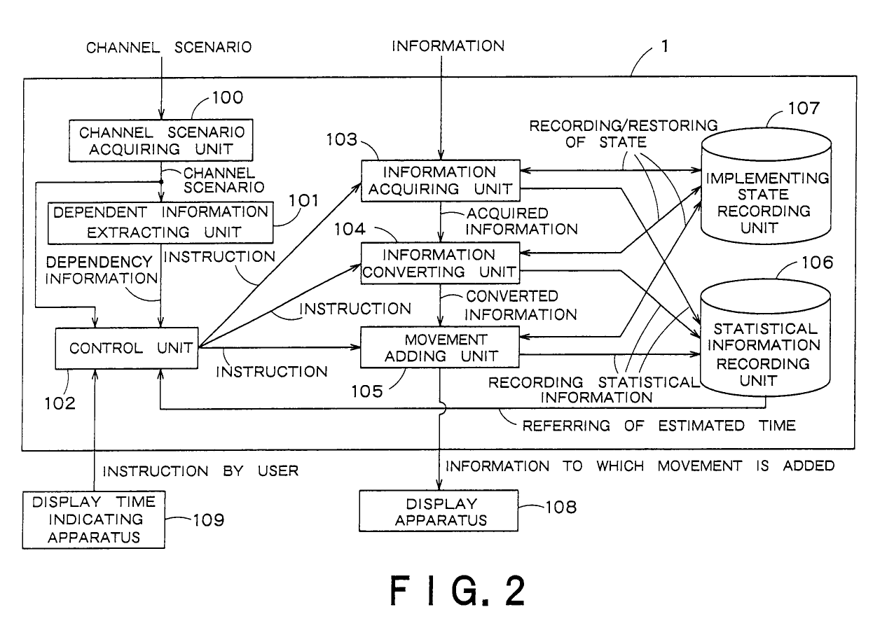

FIG. 2 schematically shows the configuration of the information processing apparatus 1. The information processing apparatus 1 is provided with a channel scenario acquiring unit 100, a dependency information extracting unit 101, a control unit 102, an information acquiring unit 103, an information converting unit 104, a movement adding unit 105, a statistical information recording unit 106, and an implementing state recording unit 107.

The channel scenario acquiring unit 100 acquires a channel scenario from the channel scenario server 2. Which scenario is acquired may be set in advance or designated by the user at that time. In addition, a channel scenario may be stored in a storage device, such as a USB flash memory or an optical disk, and read out. The storage device may store URL having the channel scenario in it.

The channel scenario includes a script having instructions for the information acquiring unit 103, the information converting unit 104 and the movement adding unit 105. Three processes: acquisition of information, conversion and extraction of information, and addition of movement to information, are carried out on the basis of the channel scenario. That is to say, what kind of information (for example websites) is acquired in what order, how the information is converted and extracted, and how movement is added to the information is described in the channel scenario, and thus, an environment in which Internet information can be “idly watched” can be easily provided.

Scripts may be set as one file or a set of a number of files. In addition, the cost of transfer may be reduced by compressing the script. In addition, channel scenarios may be encrypted. When encrypted, it becomes difficult for others to know what contents are being viewed.

The dependency information extracting unit 101 extracts dependency information which includes the dependency relationship between the processes of information acquisition, information conversion and movement addition described in the script included in the channel scenario. The dependency information is described in the following.

The control unit 102 issues instructions to the information acquiring unit 103, the information converting unit 104 and the movement adding unit 105 on the basis of the channel scenario and the dependency information.

For example, the control unit 102 divides the channel scenario into “acquisition script,” “conversion script” and “movement adding script.” Then, the control unit 102 relays the location of the external servers and the information on the network through which information is to be acquired on the basis of the “acquisition script” to the information acquiring unit 103. In addition, the control unit 102 instructs the information converting unit 104 as to what kind of information conversion to carry out on the basis of the “conversion script.” In addition, the control unit 102 instructs the movement adding unit 105 as to what kind of movement to add on the basis of the “movement adding script.”

In addition, the control unit 102 refers to the time predicted to be required for information acquisition, information conversion and movement addition, which are recorded in the statistical information recording unit 106 when issuing instructions, and determines the order of priority of the processes.

The information acquiring unit 103 acquires information from the information server 3 following the contents indicated by the control unit 102. The information acquiring unit 103 passes the acquired information on to the information converting unit 104.

The information converting unit 104 converts information received from the information acquiring unit 103 to a predetermined format following the contents indicated by the control unit 102. Here, the predetermined format is a format which is appropriate for the display in the movement adding unit 105. In addition, information can be extracted at the time of conversion in conjunction with the above “(3) The amount of information provided for viewing is limited.”

The information converting unit 104 converts the acquired information and extracts information to which meaning is given, for example. In the case where the acquired information is in HTML, for example, the probability of the title element being the title of the page is high, and the probability of the initial p element in the body element being contents is high, and as a result, meaning is extracted from the original information. This determination is different depending on the origin of the acquired information, and therefore, which process is carried out cannot be concretely determined in advance.

In addition, the conversion process in the information converting unit 104 may include “division of a static website into components to be used in the movement adding unit 105,” “rearrangement,” “integration,” “speech synthesis” and the like.

The information converting unit 104 passes the converted information on to the movement adding unit 105.

The movement adding unit 105 adds movement to the information converted by the information converting unit 104 following the contents indicated by instruction from the control unit 102. This is in order to display the information in such a format as to draw a moderate degree of the user's attention without bothering them, for example.

Information on the Internet is mainly text information without movement, and therefore changed to a display to which (originally absent) movement is added, for example, and thus, the screen display can continuously change even when the user is not operating anything.

Here, information to which meaning is given is converted to video and sound on the basis of the “changing information,” for example. The changing information is information for instructing slide-in, fadeout or change in the color of letters, for example. Titles slide in from the top with a large font, and contents fade in the center portion with a red font, for example.

The changing information is applied to the extracted information, so that continuous change (animation) can be induced. At this time, the same news site has the same information structure even when it has different contents, for example. Therefore, one piece of changing information can be applied to other contents. That is to say, a sequence of websites can be changed to an animation applying the same changing information. Furthermore, the animation can be connected so that contents of a certain length can be generated.

As concerns the addition of movement, the display contents may change when movement is added to text information, for example. In addition, there may be accompanying sound output, so that text information is outputted as synthesized sound. Though the addition of movement relates to the above-described “(1) Movement is added to the information on the Internet”, movement is not necessarily added to all of the information.

Information to which movement is added is provided to the display apparatus 108 from the movement adding unit 105 and displayed on the display apparatus 108. The display apparatus 108 is a liquid crystal display, a conventional television or the like. The display apparatus 108 may be independent of the information processing apparatus 1 or built into the information processing apparatus 1.

The statistical information recording unit 106 records the time required for the respective processes of information acquisition, information conversion and addition of movement (whenever information is displayed on the display apparatus 108). Thus, the statistical information recording unit 106 records the time for processing the contents on the display in each channel scenario (time up to final display for user after carrying out information acquisition, conversion and addition of movement).

When the same channel scenario is displayed (viewed), the statistical information recording unit 106 adds or updates recording of the time for processing the contents on each display in the channel scenario. Here, to add means to record the time for processing the contents on each display corresponding to the previous viewing, discard the time for processing corresponding to the oldest viewing in the case where the number of times of viewing exceeds a predetermined number, and instead record the time for processing which corresponds to the most recent viewing.

In addition, to update means, in a state where only the average value of previous values of the time for processing each contents on display is recorded and when a new channel scenario is viewed, to calculate and record a new average value in which the most recent time for processing is reflected. When a new channel scenario is viewed, for example, the value gained by multiplying the average value at that time by a constant α (0<α<1) and the value gained by multiplying the most recent time for processing by 1-α are added, so that the results of the addition is recorded as a new average value, for example.

Which method—addition or updating—is taken by the statistical information recording unit 106 can be determined on the basis of the capacity of the memory and the complexity of the control.

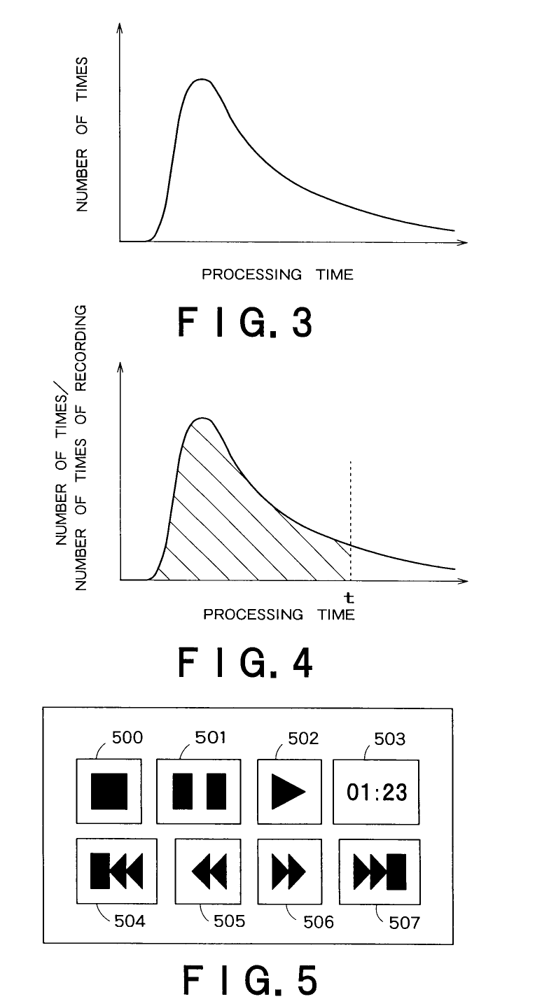

In the case where recording of the time for processing is added, a certain number of times of recording is stored, the time for processing is divided into a number of sections, so that the number of times the process is completed can be counted within each section. The histogram shown in FIG. 3 has the time for processing along the lateral axis and the number of times the process is completed along the longitudinal axis.

The time for processing is inconsistent for each viewing of the channel scenario, and it is possible for it to have a form which is close to normal distribution as the number of times of viewing increases.

Here, the certain shortest time is always required for the processing of information, and in some cases an extremely long time is required, due to congestion of the network or a server load, in order to acquire information on a network. Accordingly, as shown in FIG. 3, the number of times may be 0 for a certain shortest time on the left side at the top (side on which the time for processing is shorter) and a form of the distribution where the end may be elongated is gained on the right side at the top (side on which the time for processing is longer).

This histogram shows a previous values of the time for processing, and if it is assumed that the distribution of the time for processing will be the same in the future, the graph gained by dividing the scale of the longitudinal axis by the number of times of recording can be regarded as a graph showing a stochastic distribution of the time required for processing for future viewing.

The number of times of recording the time for processing is limited, and therefore, the area surrounded by the thus gained curve and the lateral axis is also limited. Therefore, as shown in FIG. 4, when the area surrounded by the curve and the lateral axis (hatched portion in figure) in the region where the time for processing is t or less is p (0<p<1) relative to the area surrounded by the entire curve and the lateral axis, the probability of the process completing within the predicted time t can be said to be 100×p %.

p is predetermined, and the time t is assumed to be the predicted time required for the process. When p=0.9, for example, the probability of the process of completing within the predicted time t is 90%.

The statistical information recording unit 106 calculates and records the predicted time for the contents on each display included in each channel scenario. In the case where the record of the time for processing is updated, the average value of the recorded time for processing is the predicted time.

The control unit 102 refers to the predicted time when issuing instructions to the information acquiring unit 103, the information converting unit 104 and the movement adding unit 105, and the order of priority for the process carried out in each portion is determined using the channel scenario and the dependency information.

The implementing state recording unit 107 records the results of the process in progress or the results of the completed process of the information acquiring unit 103, the information converting unit 104 and the movement adding unit 105. In the case where the results of the process in progress are recorded in the implementing state recording unit 107, the information acquiring unit 103, the information converting unit 104 and the movement adding unit 105 recover the state in progress of the process from the results of the process in progress, and can resume the process from the point where it was interrupted.

The respective contents displayed on the display apparatus 108 by the information processing apparatus 1 have the time width indicated by the channel scenario and are automatically placed in order along the time axis. Respective points along the time axis are referred to as display time. The display time starts from the starting point of the scenario, progresses along the time axis in sync with real time, and ends at the ending point of the scenario.

The display time indicating apparatus 109 instructs the control unit 102 to shift the display time to the front or rear. The display time indicating apparatus 109 is provided in the information processing apparatus 1 or a remote controller. FIG. 5 schematically shows an example of the configuration of the display time indicating apparatus 109. The display time indicating apparatus 109 is provided with a stop button 500, a pause button 501, a play button 502, a time displaying unit 503, a skip back button 504, a rewind button 505, a fast forward button 506 and a skip forward button 507.

The stop button 500 is for instructing stopping of the display of information. The pause button 501 is for instructing temporary stopping of the display. In a temporary stopped state, such processes as acquisition of information, conversion of information and addition of movement progress with the display apparatus 108 displaying the same contents, and the display time does not progress, even as real time goes on.

When the pause button 501 is pressed again or the play button 502 is pressed in a temporary stopped state, the paused state is terminated. As a result, the display time progresses together with real time, and the contents displayed on the display apparatus 108 change as the display time progresses.

The skip back button 504 is for instructing skipping to the start of the previous contents (corner) displayed on the display apparatus 108. That is to say, it gives an instruction the display time to be shifted to the starting point of the contents (corner) displayed on the display apparatus 108.

The rewind button 505 is for instructing shifting of the display time back by a certain time into the past direction. Whenever the rewind button 505 is pressed, the display time goes back by 10 seconds, for example. The fast forward button 506 is for instructing advancement of the display time by a certain time. Whenever the fast forward button 506 is pressed, the display time advances by 10 seconds, for example.

The skip forward button 507 is for instructing skipping to the next contents (corner) of the contents (corner) displayed on the display apparatus 108. That is to say, the display time is instructed to shift to the starting point of the next contents (corner) of the contents (corner) displayed on the display apparatus 108.

The time displaying unit 503 shows the display time. The display time indicating apparatus 109 needs not be provided with all of the buttons and display portions, and other buttons may be added. In addition, the same instruction may be given by means of a dial or the like instead of buttons.

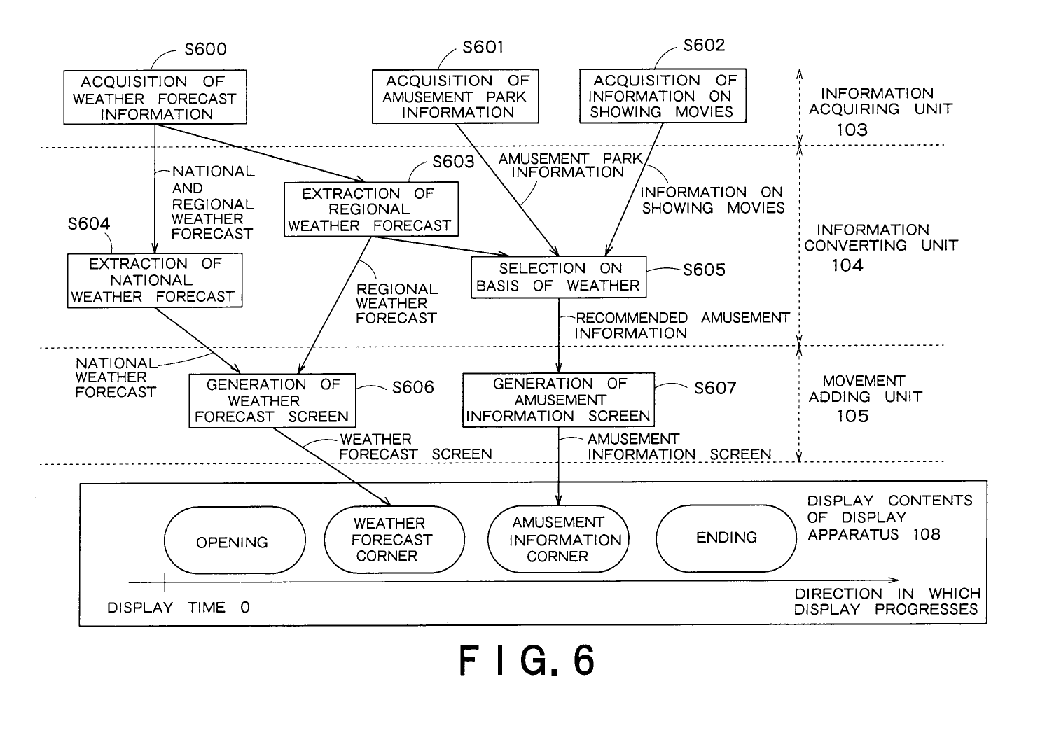

FIG. 6 shows an example where a channel scenario is displayed using the information processing apparatus 1. The channel scenario is formed of four corners: an opening, a weather forecast corner, an entertainment information corner and an ending.

The weather forecast corner and the entertainment information corner are displayed by acquiring information over the Internet, converting it and adding movement.

The operation of the information processing apparatus 1 is described in further detail below. An information acquiring unit 103 acquires weather forecast information from a server which discloses weather forecast information over the Internet (S600). The thus gained information includes national and regional weather forecast information.

An information converting unit 104 extracts the national forecast from this information (S604), and further extracts the forecast for the area where the user resides (S603). The thus gained national weather forecast and regional weather forecast are used so that the movement adding unit 105 generates a weather forecast screen (S606). This screen is displayed in the weather forecast corner.

The entertainment information corner displays information on amusement parks, where people can have fun outdoors, in the case where the forecast weather for the area where the user lives is nice, and information on the movies, where people can have fun indoors, in the case where the forecast weather is bad, for example rainy.

An information acquiring unit 103 acquires information on amusement parks from a server which discloses amusement park information over the Internet (S601), and acquires information on showing movies from a server which discloses information on showing movies (S602).

The information converting unit 104 selects either the amusement park information or the showing movies information as recommended amusement information on the basis of the regional weather forecast (S605). The thus gained recommended amusement information is used so that the movement adding unit 105 generates an amusement information screen (S607). This screen is displayed in the amusement information corner.

Here, in the example in FIG. 6, the opening and ending display contents are included in the scenario, so that predetermined contents are displayed and acquisition of information, conversion and addition of movement are not required.

When the user is not operating the fast forward or rewind button on the display time indicating apparatus 109, the display apparatus 108 displays the opening, the weather forecast corner, the entertainment information corner and the ending in the order indicated in the scenario during the time shown in the scenario. The display time progresses along the time axis in sync with real time starting from the opening, which is the starting point of the scenario, and continues through the weather forecast corner and the amusement information corner, and finishes when the display time reaches the point of completion of the ending, which is the ending point of the scenario.

The information display using this scenario can be repeated many times. Even when the scenario is the same, the information acquiring unit 103 acquires information from an information server 3 over the Internet, and therefore, the acquired information changes when the information in the information server 3 changes.

Therefore, when information is displayed repeatedly using the same scenario, the gained display contents may be different every time.

For example, it is possible for the information to be updated in a server having weather forecast information once a day. In this case, the same display contents are acquired in the weather corner in the above-described scenario, no matter how many times information is displayed on the same day, but the display contents that change together with new weather forecast information can be gained when the date changes.

Thus, it is assumed that the viewer views the above-described scenario approximately once a day, and different information is displayed every time.

In addition, a scenario which displays information that is updated more frequently may be viewed more frequently, so that different display contents are gained every time. In addition, a scenario which displays information updated less frequently is also possible, and the same display contents are gained for a relatively long period of time when the scenario is viewed. The frequency with which the display contents change as described above depends on the scenario.

The user can operate the fast forward or rewind button on the display time indicating apparatus 109. The display time can be advanced to the start of the amusement information corner instantly by pressing the skip forward button 507 while the weather forecast corner is being displayed, for example. Alternatively, the weather forecast corner can be viewed again from the beginning by pressing the skip back button 504.

A case where the user presses the skip forward button 507 of the display time indicating apparatus 109 twice in rapid immediately after the start of the play of the scenario shown in FIG. 6, that is to say, during the opening, so that the display time advances to the starting point of the amusement information corner is assumed, for example.

At this time, the information processing apparatus 1 does not carry out processes required only for generating a weather forecast screen, such as acquisition of information, conversion of information, and addition of movement, but places priority on processes required for generating an amusement information screen. Acquisition of information, conversion of information, and addition of movement, which are required only for generating a weather forecast screen, are extraction of the national weather forecast in FIG. 6 (S604) and generation of a weather forecast screen (S606). The acquisition of weather forecast information (S600) and extraction of the regional weather forecast (S603) are required for generating an amusement information screen, and are therefore carried out.

The dependency information indicating which process is necessary to display the respective corners is extracted from the scenario by means of a dependency information extracting unit 101. The same input/output relationship as in the flow shown in FIG. 6 is described in the channel scenario in advance by the creator of the channel scenario, and therefore, the dependency relationship (dependency information) can be extracted by tracing the arrow indicating the flow of data in the opposite direction.

Thus, an amusement information screen can be smoothly generated and displayed on the display apparatus 108 by lowering the priority of processes not required for generating the amusement information screen.

As another example, a case where acquisition of weather forecast information (S600) and extraction of the national weather forecast (S604) are completed a while after the start of the play of the scenario shown in FIG. 6, and then the user presses the skip forward button 507 on the display time indicating apparatus 109 during the extraction of the weather forecast for the area where the user lives (S603) so that the display time advances to the starting point of the amusement information corner is also possible.

Though the results of the extraction of the national weather forecast (S604) are not used to generate an amusement information screen, the results are recorded in the implementing state recording unit 107 without being discarded. The extraction of the weather forecast for the area where the user lives (S603) in progress is necessary for generating an amusement information screen, and therefore continues.

Then, as described above, acquisition of amusement park information (S601), acquisition of information on showing movies (S602), selection of information on recommended amusement (S605) and generation of an amusement information screen (S607) are carried out, and thus, an amusement information corner is displayed.

After that, it is assumed that the user presses the skip forward button 504 on the display time indicating apparatus 109 twice when the amusement information corner is displayed, so that the display time returns to the starting point of the weather forecast corner.

At this time, the results of extraction of the national weather forecast are recorded in the implementing state recording unit 107, and therefore, the results are restored and used to generate the weather forecast screen. It is not necessary to repeat the same process vainly, and therefore, the instruction to move the display time by the user can be smoothly carried out.

The state of the process in progress may be recorded in the implementing state recording unit 107. When the process is resumed, the state in progress is restored, so that the process can restart from the point of interruption.

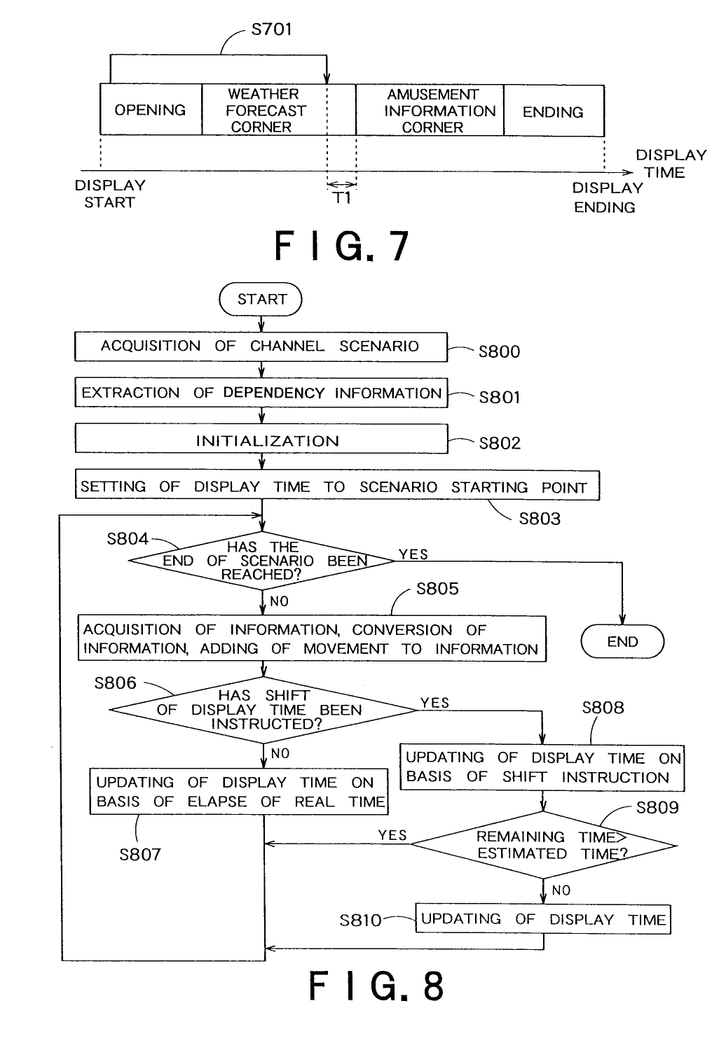

An example where the user presses the fast forward button 506 on the display time indicating apparatus 109 several times immediately after the start of the play of the scenario shown in FIG. 6, that is to say, during the opening, so that the display time advances to the middle of the weather forecast corner is also possible. FIG. 7 shows this process.

In this case, the information processing apparatus 1 is required to stop displaying the opening and immediately display the weather forecast corner starting from the time indicated by the fast forward instruction (S701) by the user (middle of weather forecast corner).

In this case, however, it is assumed that the remaining time T1 for the weather forecast corner shown in the scenario is only 10 seconds, for example. If the time required for acquiring weather forecast information (S600), the extraction of the national weather forecast (S603), the extraction of weather forecast for the area where the user lives (S604) and the generation of a weather forecast screen (S606) is 20 seconds, the information processing apparatus 1 cannot display the weather forecast corner.

This is because the display time advances before the completion of the weather forecast screen, and it becomes the time for the amusement information corner to be displayed.

In addition, the 20 seconds required for generating a weather forecast screen are longer than the remaining time T1 for the weather forecast corner (10 seconds), and therefore, the initial 10 seconds in the amusement information corner are spent for the generation of the weather forecast screen, which is at that point already unnecessary.

Then, the process for generating an amusement information screen is started, after the generation of the weather forecast screen. In the case where the time required for generating an amusement information screen is 10 seconds, the display is interrupted for 30 seconds, including the time required for generating the weather forecast screen. Therefore, in the embodiment, the control unit 102 refers to the time t predicted to be required for generating a weather forecast screen, which is recorded in the statistical information recording unit 106 immediately after the fast forward instruction is given by the user (S701) , and when it is no less than the remaining time T1 for the weather forecast corner, the priority of the process required only to generate a weather forecast screen is lowered, while the priority of the process required for generating an amusement information screen is increased.

The process required only for generating a weather forecast screen and the process for generating an amusement information screen can be specified on the basis of the dependency information.

As a result, though there is no display during the remaining time T1 for the weather forecast corner, the process for generating an amusement information screen is started without carrying out the process for generating a weather forecast screen, and thus, the time during which the display is interrupted can be shortened.

In the case where ten seconds are required for generating an amusement information screen, for example, the process can be completed during the remaining time T1 for the weather forecast corner, and the amusement information screen can be displayed on time for displaying the amusement information screen.

As described above, the control unit 102 compares the time remaining for the corner after the movement with the predicted time for the corner recorded in the statistical information recording unit 106 to be displayed on the display apparatus 108 in the case where movement of the display time is instructed. Then, in the case where the remaining time is shorter, the control unit 102 lowers the priority of the process required only to display the corner and increases the priority of the process required for displaying the next corner, so that the display for the next corner is prepared, and thus, the time during which the display is interrupted in the display apparatus 108 can be shortened.

This operation of the information processing apparatus 1 is described in reference to the flow chart in FIG. 8.

The channel scenario acquiring unit 100 acquires a channel scenario from the channel scenario server 2 (Step S800).

The dependency information extracting unit 101 extracts dependency information including the dependency relationship between the respective processes described in the channel scenario: information acquisition, information conversion and addition of movement (Step S801).

The control unit 102 initializes the information acquiring unit 103, the information converting unit 104 and the movement adding unit 105. That is to say, when the portions are carrying out one of the processes, the process is interrupted and the internal state is initialized (Step S802).

The display time is set to the starting point of the scenario. This is to display the scenario from the start (Step S803).

When the display time reaches the end of the scenario, the process ends, and when it does not reach the end, the process goes to the step S805 (Step S804).

The control unit 102 controls the information acquiring unit 103, the information converting unit 104 and the movement adding unit 105 on the basis of the channel scenario, the dependency information, the display time and the priority of the process. The time required for the process in the respective portions is relayed to the statistical information recording unit 106. The statistical information recording unit 106 records the sum of the time for the process in the respective portions, that is to say, the time required to prepare for display for each piece of information. This time is added or updated whenever the portion carries out a process (Step S805).

In the case where the user instructs movement of the display time using the display time indicating apparatus 109, the process goes to step S808, and in the case where there is no such instruction, the process goes to Step S807 (Step S806).

The control unit 102 advances the display time by the same amount as elapse of real time (Step S807).

The control unit 102 moves the display time on the basis of the movement instruction (Step S808).

the control unit 102 compares the remaining time from the display time after movement to the completion of the corner with the time predicted to be required to prepare display of the corner. In the case where the remaining time is longer than the predicted time, the process returns to the Step S804. In the case where the predicted time is no less than the remaining time, the process goes to the step S810 (Step S809).

The display time advances to the end point of the corner, which corresponds to the display time after the movement in the Step S808 (starting point of the next corner of the corner).

Then, the priority of the process required only for the display of the corner is lowered, and the priority of the process required to display the next corner of the corner is increased (Step S810).

In the above-described operation, time can be allocated to a process for useful information, such as information on the next corner, without carrying out a process for information determined not to be displayed on time from the predicted time required for the process. The time during which the display is interrupted can be shortened by omitting wasteful processes, so that the display of information can resume smoothly in response to instructions from the user, such as fast forwarding and rewinding.

Thus, the information processing apparatus according to the embodiment makes it possible to change the screen for displaying information acquired over the Internet without active operation by the user, and thus, the time during which the display of information is interrupted can be shortened.

In the embodiment, the time for the respective processes of information acquisition, information conversion and movement addition, which are required for displaying information is recorded in the statistical information unit 106, and the time may be referred to by the control unit 102 as the predicted time for the respective processes.

In the case where the information processing apparatus 1 can simultaneously carry out a number of processes in parallel according to the predicted time for the respective processes, better parallel scheduling is possible in the Step 5805 in FIG. 8.

In addition, though in the embodiment, the statistical information recording unit 106 records only the time required for the process, the memory capacity required for the process may also be recorded. That is to say, not only chronological cost, that is, the time required for the process, but also spatial cost, that is, the memory capacity required for the process, can be taken into consideration. The estimate of the required memory capacity can be predicted in accordance with the same method as for the time for processing.

A storage device with a limited capacity is usually mounted in the information processing apparatus 1. Therefore, processes using prediction of the memory capacity can be selected in the case where processes are carried out in parallel, as described above, or processes required for displaying the previous corner are carried out in advance.

In the case where a number of processes are possible, first the sum of the predicted capacity of the memory to be used is calculated, in the case where the respective processes are carried out. In addition, in the case where it exceeds the total capacity of the memory in the information processing apparatus according to the embodiment, the process is not carried out, and another process is prioritized. As a result, processes can be prevented from being carried out in parallel or in an inappropriate order, and thus, the memory capacity can be prevented from running short.

When the control unit 102 of the information processing apparatus 1 receives an instruction relating to the display time from the user via the display time indicating apparatus 109, the predicted cost (time for processing and/or memory capacity) for displaying the corner corresponding to the indicated display time is acquired from the statistical information recording unit 106. Then, the control unit 102 controls the information acquiring unit 103, the information converting unit 104 and the movement adding unit 105, so that the process for displaying the corner can be carried out in the case where the acquired predicted cost is within an allowable range (remaining time for the corner and/or available memory capacity). In other words, the control unit 102 increases the priority of the process for displaying the corner.

Meanwhile, the control unit 102 controls the information acquiring unit 103, the information converting unit 104 and the movement adding unit 105, so that the process for displaying the next corner of the corner can be carried out in the case where the acquired predicted cost is not within an allowable range. In other words, the control unit 102 increases the priority of the process for displaying the next corner of the corner. In addition, the priority of the process for displaying only the corner can be lowered.

At least part of the information processing apparatus described in the above embodiments may be implemented in either hardware or software. When implemented in software, a program that realizes at least part of functions of the information processing apparatus may be stored on a recording medium such as a flexible disk or CD-ROM and read and executed by a computer. The recording medium is not limited to a removable recording medium such as a magnetic disk or optical disk, but may be a non-removable recording medium such as a hard disk device or memory.

The program that realizes at least part of the functions of the information processing apparatus may be distributed through a communication line (including wireless communications) such as the Internet. Further, the program may be encrypted, modulated, or compressed to be distributed through a wired line or wireless line such as the Internet or to be distributed by storing the program on a recording medium. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus which acquires information over a network and processes the information to be displayed to a user on the basis of a scenario including an acquisition script, a conversion script and a movement adding script, comprising:
an information acquiring unit which acquires a plurality of pieces of information over the network in accordance with the acquisition script;
an information converting unit which extracts portions represented to the user from the respective pieces of information acquired by the information acquiring unit in accordance with the conversion script;
a movement adding unit which processes all or part of the presented portion extracted by the information converting unit so that display contents can be presented in such a form as to automatically change and/or be accompanied with the sound output in accordance with the movement adding script;
a statistics recording unit which records a first cost for the information acquiring unit to acquire information, a second cost for the information converting unit to extract the presented portion and a third cost for the movement adding unit to carry out the process;
an extraction unit which extracts dependency information showing a dependency relationship between the processes in the information acquiring unit, the information converting unit and the movement adding unit from the scenario; and
a control unit which determines the priority of the processes to be carried out on the basis of the scenario, the dependency information and the first to third cost, and controls the information acquiring unit, the information converting unit and the movement adding unit.

2. The apparatus according to claim 1, wherein the first to third cost are time required for processing.

3. The apparatus according to claim 1, wherein the first to third cost are memory capacity required for processing.

4. The apparatus according to claim 1, wherein the control unit increases the priority of the process for preparing the display contents corresponding to the indicated display time in the case where the display time for the display contents is indicated.

5. The apparatus according to claim 1, wherein the control unit acquires the first to third cost when preparing the first display content corresponding to the indicated display time from the statistics recording unit, when the display time for the display contents is indicated, and increases the priority of the process for preparing the first display content in the case where the acquired cost is within an allowable range, and increases the priority of the process for preparing a second display content which is different from the first display content in the case where the acquired cost is outside the allowable range.

6. The apparatus according to claim 5, wherein the control unit lowers the priority of the process for preparing only the first display content in the case where the acquired cost is outside the allowable range.

7. The apparatus according to claim 5, wherein
the first to third cost are time required for processing, and
the control unit increases the priority of the process for preparing the first display content in the case where the time required for preparing the first display content is shorter than the remaining time during which the first display content is displayed, and increases the priority of the process for preparing the second display content that is displayed for the user following the first display content in the case where the required time is no shorter than the remaining time.

8. The apparatus according to claim 1, wherein the acquisition script contains instructions as to how to acquire information for the information acquiring unit, the conversion script contains instructions as to how to extract information for the information converting unit, and the movement adding script contains instructions as to how to process information for the movement adding unit.

9. An information processing method using an information processing apparatus comprising an information acquiring unit, an information converting unit, a movement adding unit, a statistics recording unit, an extraction unit and a control unit, which acquires information over a network and carries out a process on information displayed to a user on the basis of a scenario including an acquisition script, a conversion script and a movement adding script, wherein
the extraction unit extracts dependency information showing a dependency relationship between the respective processes in the information acquiring unit, the information converting unit and the movement adding unit from the scenario,
the control unit determines the priority of the processes to be carried out on the basis of the scenario, the dependency information and the cost for the processes in the information acquiring unit, the information converting unit and the movement adding unit, which is recorded in the statistics recording unit, and gives instructions to the information acquiring unit, the information converting unit and the movement adding unit,
the information acquiring unit acquires a number of pieces of information over the network in accordance with the acquisition script and an instruction from the control unit,
the information converting unit extracts portions presented to the user from the respective pieces of information acquired by the information acquiring unit in accordance with the conversion script and an instruction from the control unit,
the movement adding unit processes all or part of the presented portions extracted by the information converting unit so that the portions are presented in such a form that the display contents automatically change and/or are accompanied by the sound output in accordance with the movement adding script and an instruction from the control unit, and
the statistics recording unit records a first cost for the information acquiring unit to acquire information, a second cost for the information converting unit to extract the presented portions, and a third cost for the movement adding unit to carry out the process.

10. A computer readable recording medium which records a program which allows a computer to function as an information processing apparatus for acquiring information over a network and carrying out a process on information displayed to a user on the basis of a scenario including an acquisition script, a conversion script and a movement adding script, wherein the program allows a computer to have:
a function for allowing an information acquiring unit to acquire a number of pieces of information over the network in accordance with the acquisition script;
a function for allowing an information converting unit to extract portions presented to the user from the respective pieces of information acquired by the information acquiring unit in accordance with the conversion script;
a function for allowing a movement adding unit to process all or part of the presented portions extracted by the information converting unit so that the respective portions are presented in such a form that the display contents automatically change and/or are accompanied by the sound output in accordance with the movement adding script;
a function for allowing a statistics recording unit to record a first cost for the information acquiring unit to acquire information, a second cost for the information converting unit to extract the presented portions, and a third cost for the movement adding unit to carry out the processes;
a function for allowing an extraction unit to extract dependency information showing dependency relationship between the respective processes in the information acquiring unit, the information converting unit and the movement adding unit from the scenario; and
a function for allowing a control unit to determine the priority of the processes to be carried out on the basis of the scenario, the dependency information and the first to third cost, and to give instructions to the information acquiring unit, the information converting unit and the movement adding unit.
